(19) United States
(12) Patent Application Publication
(10) Pub. No.: US 2026/0150812 A1
(43) Pub. Date: Jun. 4, 2026

(54) PET BANDANA WITH BREAKAWAY CLASP

(71) Applicant: Donna Bogari, Lancaster, PA (US)

(72) Inventor: Donna Bogari, Lancaster, PA (US)

(21) Appl. No.: 19/182,093

(22) Filed: Apr. 17, 2025

Related U.S. Application Data
(60) Provisional application No. 63/727,421, filed on Dec. 3, 2024.

(51) Int. Cl. A01K 13/00

(52) U.S. Cl. CPC A01K 13/006

(57) ABSTRACT

A pet bandana comprising a fabric body and a breakaway clasp system configured to secure the bandana around a pet's neck. The clasp system includes male and female components that are configured to release automatically when a predetermined pulling force is applied to the bandana, preventing strangulation or entanglement. The bandana may optionally include reinforced stitching, reflective material, water-resistant coatings, or an integrated identification tag. The invention offers a secure yet easy-to-apply and remove design, combining convenience with enhanced protection, which standard bandanas lack.

### CROSS REFERENCE TO RELATED APPLICATION

This application claims the benefit of priority of U.S. provisional application No. 63/727,421, filed Dec. 3, 2024, the contents of which are herein incorporated by reference.

### BACKGROUND OF THE INVENTION

The widespread use of pet bandanas has become an essential part of modern pet ownership, serving as a means to express one's pet's unique personality and provide comfort during outings or in everyday life. However, the current designs and materials used in traditional pet bandanas have been found wanting in terms of safety and practicality.

For many years, pet owners have relied on conventional methods of securing their pets'bandanas, such as tying knots, using buckles, or relying on loose fabric to stay in place. Unfortunately, as demonstrated in the following studies, these approaches have proven to be problematic, as they can easily become tangled or snagged, posing a significant risk of choking or injury to the pet.

### Dog Collar-Related Strangulation

The Ryder Safe Foundation estimates that approximately 26,000 dogs die annually due to collar-related strangulation. This number is based on reports collected by pet professionals and industry experts, although the foundation acknowledges that the actual number may be higher due to underreporting.
   Source: Ryder Safe Foundation—Collar Safety, available at https://www.rydersafefoundation.com/collar-safety-new.

### Cat Collar-Related Strangulation

A 2022 study published in the Journal of Veterinary Behavior found that in cases of fatal collar injuries, 92.9% were due to the collar becoming caught on an object such as a fence (66.6%) or tree branch (33.3%).
   Source: ScienceDirect—Collar-related injuries in cats, available at https://www.sciencedirect.com/science/article/pii/S1558787822001 204.

Furthermore, these traditional methods often require an owner's attention and dexterity, which can be difficult or impossible for owners with pets that are strong or restless.

The limitations of conventional pet bandanas have led to a growing concern among pet owners regarding the potential risks associated with their use. Many pets have suffered injuries or near-accidents due to entanglement or choking, resulting in unnecessary stress and anxiety for both pets and owners. Moreover, the inconvenience and frustration caused by these traditional designs can lead to a decrease in their overall adoption and usage.

In light of these concerns, it is clear that there exists a pressing need for a more advanced, safer, and user-friendly solution for securing pet bandanas. The development of a novel, breakaway clasp system has the potential to revolutionize the way pets are accessorized, providing a secure attachment method that permits automatic release under tension, thereby enhancing safety. Therefore, the need exists for a solution that addresses the shortcomings of traditional pet bandanas and ensures the safety, comfort, and style of pets and their owners alike.

### SUMMARY OF THE INVENTION

The present invention relates to a novel pet bandana with a breakaway clasp system designed to ensure the safety and comfort of pets while providing pet owners with an easy-to-use, secure, and stylish accessory. The invention includes a bandana fabric with two ends for tying or securing, a breakaway clasp system consisting of male and female components that work together seamlessly to secure the bandana around a pet's neck and means for releasing the breakaway clasp system in response to tension on the bandana.

The invention provides a unique solution to the safety concerns associated with traditional pet bandanas by incorporating a breakaway clasp system that automatically releases when under tension, preventing choking or entanglement. The invention also offers a secure yet easy-to-remove design, combining convenience with enhanced protection, which standard bandanas lack.

In summary, the present invention is a novel pet bandana with a breakaway clasp system that provides a safe and comfortable accessory for pets while offering an easy-to-use and stylish solution for pet owners.

These and other features, aspects and advantages of the present invention will become better understood with reference to the following drawings, description and claims.

### BRIEF DESCRIPTION OF THE DRAWINGS

FIG. 1 is a perspective view of the invention, showing the bandana in its unfolded state;

FIG. 2 is a front perspective view of the invention with the clasp buckled;

FIG. 3 is a rear perspective view of the invention with the clasp buckled;

FIG. 4A is a top view of the invention, ready to be placed on a dog; and

FIG. 4B is a top view of the invention, showing the clasp being buckled on the dog's neck.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

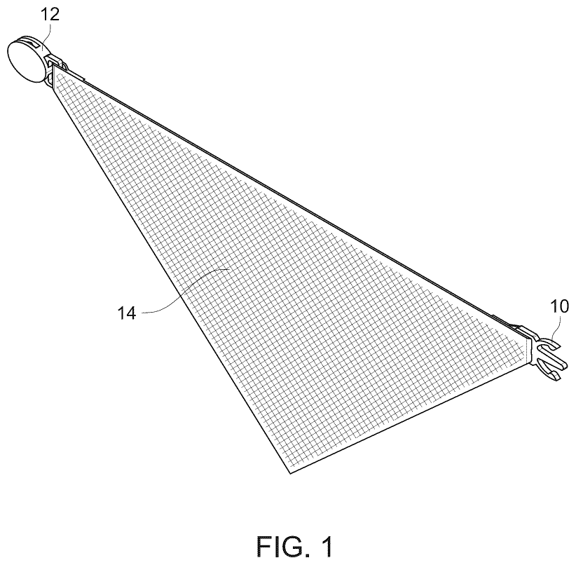

The present invention, as depicted in FIGS. 1-4B, relates to a novel Pet Bandana with Breakaway Clasp designed to ensure the safety and comfort of pets while providing pet owners with an easy-to-use, secure, and stylish accessory.

FIG. 1 is a perspective view of the invention laid flat, showing the bandana (14) in its unfolded state. The bandana includes a main body of fabric with two ends that can be tied or secured in various ways to the clasp system in order to accommodate different pet sizes and neck shapes. The bandana 14 of the present invention can be produced in various designs, sizes, and materials to cater to different pet breeds and owner preferences, making it a versatile and appealing product in the pet accessory market. The breakaway clasp system consists of male (10) and female (12) components that are designed to work together.

The breakaway clasp system used in the present invention is designed to release automatically when a sufficient pulling force is applied, thereby protecting the dog from potential harm. In particular, the breakaway clasp includes a mechanism that is triggered by the application of a certain amount of tension to the bandana. When this tension is exceeded, the mechanism releases the connection between the male and female components, causing the clasp to open and the bandana to become detached from the dog's neck.

This design feature provides a number of benefits for both dogs and their owners. First, it helps to prevent accidents caused by entanglement or choking, which can be a significant concern when using traditional pet bandanas. Second, it allows for easy removal of the bandana if needed (such as in an emergency), without requiring the owner to manually release the clasp.

Overall, the breakaway clasp system used in the present invention provides a safe and convenient way to secure a bandana around a dog's neck, while also protecting the dog from potential harm.

As an alternative embodiment, a magnetic breakaway clasp could be used to secure the bandana around the pet's neck. This design would utilize magnets of sufficient strength that are capable of holding the bandana in place until they are released by sufficient pulling force. Other clasp designs are contemplated as a matter of design choice. For example, the breakaway clasp could comprise a Velcro-based breakaway, an elastic tension release, a snap-button safety release, or a smart clasp (with sensor-triggered release), to name a few.

As seen in FIGS. 1-4B, the primary components of the present invention include:
Breakaway Clasp 10/12: A clasp designed to release under pressure, ensuring pet safety.
Fabric Bandana 14: Made from durable, breathable, machine washable cotton fabric, cut into various sizes, folded and sewn into triangular shape, with various design options.

Optional components for use in connection with the present invention include:
A Logo Tag: A small woven label featuring the brand logo, made from fabric, attached to the bandana for branding.
Reinforced Stitching: Double-stitched seams around the clasp for added durability and strength.
Reflective Striping: Adding reflective strips to the bandana could enhance visibility during nighttime walks, improving safety for pets and their owners.
Water-Resistant Coating: Incorporating a water-resistant treatment on the fabric could protect against moisture and make the bandana more versatile for outdoor use.
Adjustable Neck Strap: A more robust adjustable neck strap could be integrated for even better fit adjustments, catering to a wider range of pet sizes.
Built-in ID Holder: An attached pocket or holder for an ID tag could

enhance safety by providing essential information in case the pet gets lost.

The Fabric Bandana (14) forms the primary body of the product and serves as the canvas for the other elements. The Breakaway Clasp (10/12) is attached to the bandana at the ends. The clasp is integral to the design, allowing the bandana to be securely fastened around the pet's neck while also enabling it to release easily under pressure. The Reinforced Stitching can be applied to attach the breakaway clasp to ensure durability and strength, preventing wear and tear during use. The Logo Tag can be attached to the bandana, enhancing branding while not interfering with the overall design or functionality of the bandana.

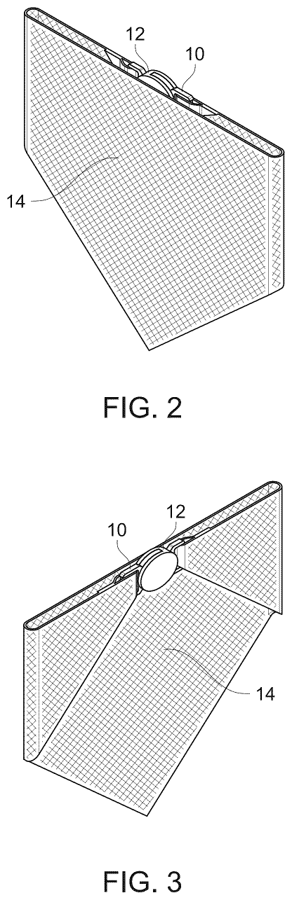

FIG. 2 is a front perspective view of the invention with the clasp buckled, illustrating how the breakaway clasp system secures the bandana around the pet's neck. In this figure, the male component (10) of the breakaway clasp system is engaged with the female component (12), forming a secure yet easy-to-release connection.

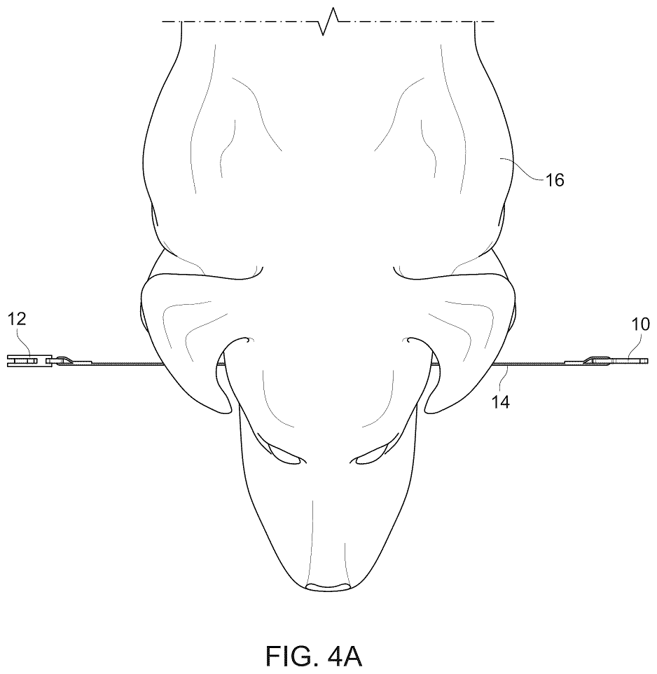

FIG. 3 is a rear perspective view of the invention with the clasp buckled, showing the same breakaway clasp system as in FIG. 2 from a different angle. This figure provides additional insight into the design and functionality of the breakaway clasp system and how the ends of the bandana 14 are secured to the clasp system.

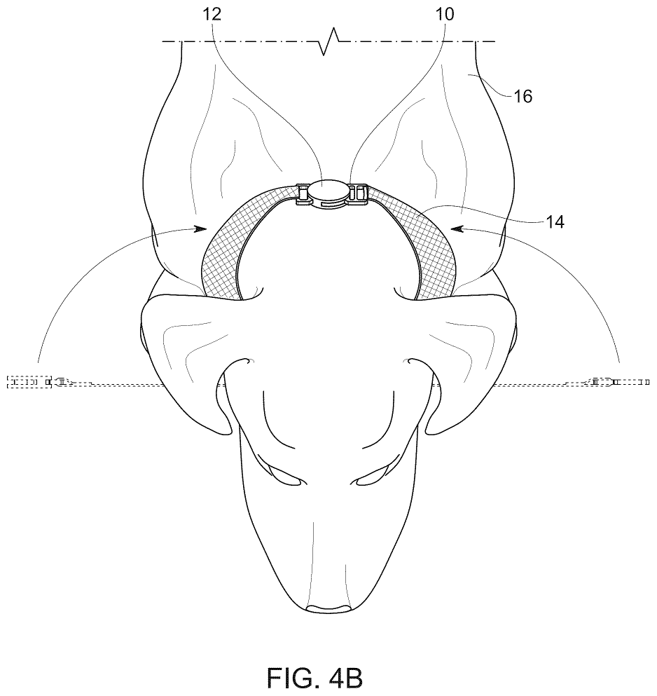

FIG. 4A is a top view of the invention, showing the bandana 14 ready to be placed on the dog (16). In this figure, the bandana (14) is shown in its unfolded state, with the two ends still loose. The breakaway clasp system components (10 and 12) are shown in an open state.

FIG. 4B is a top view of the invention, showing the clasp being buckled on the dog's neck (16). In this figure, the bandana (14) is secured around the pet's neck using the breakaway clasp system components (10 and 12). This figure demonstrates the ease with which the bandana can be put on and taken off, as well as its secure fit.

In summary, the present invention provides a novel Pet Bandana with Breakaway Clasp that addresses the safety concerns associated with traditional pet bandanas. By incorporating a breakaway clasp system into the design, this invention offers a more safe and secure yet easy-to-use accessory for pets and their owners alike.

It should be understood, of course, that the foregoing relates to exemplary embodiments of the invention and that modifications may be made without departing from the spirit and scope of the invention as set forth in the following claims.

What is claimed is:

1. A pet bandana with an integrated breakaway clasp, comprising:
a bandana fabric having two ends for tying or securing; a breakaway clasp system consisting of a male component and a female component, said components being designed to work together seamlessly to secure said bandana around a pet's neck; wherein the breakaway clasp is designed to release in response to a predetermined pulling force on the bandana, wherein when said force is applied, said breakaway clasp system automatically releases, allowing the bandana to be removed from the pet's neck.

2. The pet bandana of claim 1, wherein the breakaway clasp comprises a mechanical linkage between said male and female components.

3. The pet bandana of claim 1, wherein the breakaway clasp comprises a magnetic attraction between said male and female components.

4. The bandana of claim 1, wherein said breakaway clasp system is adjustable to accommodate different pet sizes and neck shapes.

5. The pet bandana of claim 1, wherein said fabric has an outer surface with an aesthetically pleasing design or pattern.

6. The pet bandana of claim 1, wherein the breakaway clasp is formed from plastic, metal, or composite materials.

7. The pet bandana of claim 1, wherein the pulling force is adjustable.

8. The pet bandana of claim 1, wherein the bandana fabric comprises a reflective material.

9. The pet bandana of claim 1, further comprising an identification tag or information holder.

10. The pet bandana of claim 1, wherein the bandana fabric comprises reinforced stitching around the breakaway clasp.
